(19) United States
(12) Patent Application Publication
(10) Pub. No.: US 2016/0217221 A1
(43) Pub. Date: Jul. 28, 2016

(54) Package Material Modelling

(71) Applicant: AXIOM CONSULTING PRIVATE LIMITED, Bangalore (IN)

(72) Inventors: Praveen Bhat, Udupi (IN); Trivikram Srinivasan Belagod, Bangalore (IN); Chandrasekhar Jagannath Arcot, Bangalore (IN); Lakshminarayana Giridhar, Bangalore (IN); Satya Simha Rao, Bangalore (IN)

(73) Assignee: Axiom Consulting Private Limited, Bangalore, KA (IN)

(21) Appl. No.: 14/915,916

(22) PCT Filed: Sep. 2, 2014
(86) PCT No.: PCT/IB2014/064188

§ 371 Date: Mar. 2, 2016

(30) Foreign Application Priority Data
Sep. 2, 2013 (IN) 3915/CHE/2013

(51) Int. Cl. G06F 17/50; G06N 3/04

(52) U.S. Cl. CPC G06F 17/50; G06N 3/04

(57) ABSTRACT

The present subject matter discloses systems and methods package material modeling in an enterprise. The method includes computing stress values and strain values utilizing input data. The method further includes generating a primary material model utilizing the stress values and the strain values, wherein the primary material model is indicative of the material behavior characteristics. Furthermore, the method includes estimating a coefficient of error and a trend factor; wherein the coefficient of error is indicative of error in the primary material model, wherein the trend factor is indicative of the trend in difference between historical data and the primary material model.

### TECHNICAL FIELD OF THE INVENTION

The present subject matter relates, in general, to material modeling and, in particular, to systems and methods for package material modeling.

### BACKGROUND OF THE INVENTION

Generally, packaging is the art, science, and technology of enclosing or protecting products for distribution, storage, sale, and use. In addition, packaging also refers to the process of design, evaluation, and production of packages. In other words packaging may also be described as a coordinated system of preparing goods for transport, warehousing, logistics, sale, and end use. Package contains, protects, preserves, transports, informs, and sells.

Typically, corrugated fiberboard sometimes known as corrugated board or corrugated cardboard, which is a combination of paper-based material consisting of a fluted corrugated medium and one or two flat linerboards, is used for packaging goods. In addition, multiple plys consisting of one or more corrugated cardboard may also be used for packaging goods. Such corrugated fiberboard typically designed and formed in to boxes for packaging goods. Corrugated boxes are used frequently as shipping containers. Corrugated boxes also provide some measure of product protection by themselves but often require inner components such as cushioning, bracing and blocking to help protect fragile contents.

Corrugated box design and testing is the process of matching design factors for corrugated fiberboard boxes with the functional physical, processing and end-use requirements and then testing the same for durability. Generally, engineers work to meet the performance requirements of a box while controlling total costs.

### SUMMARY OF THE INVENTION

This summary is provided to introduce concepts related to systems and methods of package material modeling are further described below in the detailed description. This summary is neither intended to identify essential features of the claimed subject matter nor is it intended for use in determining or limiting the scope of the claimed subject matter.

In one implementation, the method includes computing stress values and strain values utilizing input data. The method further includes generating a primary material model utilizing the stress values and the strain values, wherein the primary material model is indicative of the material behavior characteristics. Furthermore, the method includes estimating a coefficient of error and a trend factor; wherein the coefficient of error is indicative of error in the primary material model, wherein the trend factor is indicative of the trend in difference between historical data and the primary material model.

### BRIEF DESCRIPTION OF DRAWINGS

The detailed description is described with reference to the accompanying drawings. In the figures, the left-most digit(s) of a reference number identifies the drawing in which the reference number first appears. The same numbers are used throughout the drawings to reference like/similar features and components.

FIG. 1 illustrates a network environment implementing a package material modeling system, according to an embodiment of the present subject matter.

FIG. 2 illustrates the package material modeling system, according to an embodiment of the present subject matter.

FIG. 3 illustrates an exemplary method of package material modeling, according to an embodiment of the present subject matter.

### DETAILED DESCRIPTION OF THE INVENTION

System and method of packaging modeling materials are described herein. The system and methods can be implemented in variety of computing systems. Examples of such computing system include but are not restricted to High Performance Computing (HPC), main frame computers, workstation, personal computers, desktop computers minicomputers, servers, multiprocessor system, laptop, network server and the like.

As discussed, packaging is the science, art, and technology of enclosing or protecting products for distribution, storage, sale, and use. Further, packaging is classified in to primary packaging, secondary packaging and tertiary packaging. Primary packaging is that which surrounds a product when sold to a final consumer. Primary packaging is most often seen by the consumer and that of which they are most conscious. Primary packaging is also in direct contact with the product which adds complexity in terms of food safety requirements, hygiene requirements, etc. Primary packaging also includes packaging material that is included with the primary pack, such as a label on a jar, a cardboard sleeve on a tray, or a lid on a bottle.

Secondary or grouped packaging is that which is used to collate primary units for ease of handling in the selling environment. Typically this packaging can be corrugated cardboard boxes or trays, containing a number of primary units. Variations include shelf ready packaging which can be placed directly on a shelf in a supermarket for a consumer to pick from, or carry-out packaging such as a cardboard carry out case for multiple bottles of wine so that the consumer can carry the pack away. Tertiary or transport packaging is that which is used to facilitate handling and transport of a number of secondary packs in order to prevent handling and transport damage. Typically this packaging can be pallets, stretch-wrap plastic film or shrink-wrapped plastic hoods. This type of packaging could also include additional items such as cardboard corner guards, layer pads or pallet caps.

Package development involves considerations for sustainability, environmental responsibility, applicable environmental and recycling regulations. It may involve a life cycle assessment which considers the material and energy inputs and outputs to the package, the packaged product, the packaging process, the logistics system, waste management, etc. It is necessary to know the relevant regulatory requirements for point of manufacture, sale, and use.

Package design and testing is an integral part of the new product development process. In some cases, development of a package may be a separate process, but is linked closely with the product to be packaged. Package design starts with the identification of all the requirements, for example, structural design, marketing, shelf life, quality assurance, logistics, legal, regulatory, graphic design, end-use, environmental, etc. Package design and testing processes often employ conventional rapid prototyping, computer-aided design, computer-aided manufacturing, document automation and physical testing.

Typically, conventional package design and testing systems utilize a 2-dimension model of the packaging material, for example a 2 dimension model of the corrugated cardboard sheet. Further, generation of such 2-dimension model of the packaging material necessitates a substantial amount of physical testing and data gathering. Thus resulting in wastage of time and material, in turn increasing the overall cost. In most of the conventional 2-dimensional system the model generated are inaccurate which lead to inaccurate packaging design, resulting in failures during operation and substantial rework of package design. Furthermore, the conventional 2-dimensional systems for generating material model are complex and developed keeping for metals such as steel. Thus, the conventional systems are unable to cope with other type of material which has totally distinct properties for example, paper.

In accordance with the present subject matter, a system and a method of material model generation is described herein. In an implementation, input is obtained from the user and database. The input includes material properties, and historical data. Further, based on the input data stress values and strain values are computed. Furthermore, based on the computed stress values and strain values a primary material model is generated. In an example, artificial numeral network may be used to compute the stress values and strain values and generate the primary material model.

In the said implementation, a coefficient of error and a trend factor is estimated utilizing the historical material models, and the primary material model. The stress values and strain values are recomputed based on the trend factor and coefficient of error to generate a secondary material model. In an example, artificial neural network may be used to re-compute the stress values and strain values and generate the secondary material model. In another example evolutionary algorithm may be utilized to re-compute the stress values and strain values and generate the secondary material model

Subsequently, a 2-dimension model of the packaging material is developed utilizing the geometric features included in the input data and the secondary material model indicative of the material behavior characteristics enabling virtual package design and testing. In an example, the 2-dimensional material model may be a bi-linear 2-dimensional material model. In another example, the 2-dimensional material model may be an orthotropic 2-dimensional material model. The system and method for material model generation eliminates physical testing this reducing the overall time and effort required to generate material models. Thus reducing the over cost of the process. Further, material wastage due to repeated physical testing is prevented. It is robust and configurable to multiple types of material. These and other features along with the advantages of the present subject matter will be further being evident in the subsequent detailed description in conjunction with the figures.

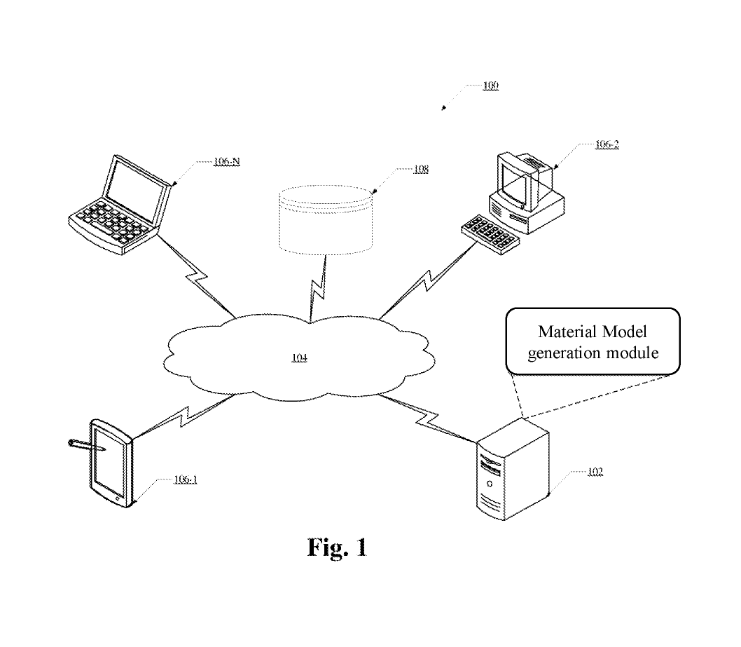

FIG. 1 illustrates a network environment 100 implementing a package material modeling system 102, according to an implementation of the present subject matter. In the said implementation, the network environment 100 includes the package material modeling system 102, herein after referred as the system 102, configured to model 2-dimension (2-D) models of packages which may be utilized for virtual testing. In an example, the 2-D models may be of boxes made up of corrugated cardboard.

The system 102 may be implemented in a variety of computing system, such as laptop computer, a desktop computer, a notebook and the like. In other implementation, the material modeling system 102 may be included in an already implemented information technology system or any package design system.

Further, the system 102 may be communicatively coupled to user devices 106-1, 106-2 . . . , 106-N, collectively referred to as device(s) 106. For example, the devices 106 may include, but not limited to a desktop computer, a mobile phone, a handheld device, a workstation, and a laptop computer. Moreover, the devices 106 individually may be located in geographically distant location from each other as well as the system 102. In one more implementation the system 102 may be configured inside the device 106.

In another implementation, the devices 106 and the system 102 may be communicatively coupled through a network 104. The network 104 may be a wireless network, wired network or a combination thereof. The network 106 can be implemented as one of the different types of network such as intranet, local area network (LAN), wide area network (WAN), the internet and such. The network may either be a dedicated network or a shared network, which represents an association of the different types of network that use a variety of protocol for example, Hypertext Transfer Protocol (HTTP), Transmission Control Protocol/Internet Protocol (TCP/IP), Wireless Application Protocol (WAP) for communication. Further, the network 104 may include a variety of network devices, including but not limiting to routers bridges, servers, computing devices, storage devise. For maintaining readability adhering to the subject matter of the present invention, the variety of network devices have not been described. It may be understood that the network may include all the various network devices, as known to a person skilled in the art.

In the implementation a database 108 is communicatively coupled directly to the system 102 or through the network 104. The database 108 may be located in a geographically similar location or in a geographically distinct location as the system 102 or any of the devices 106. In another implementation the database may be located internally to the system 102. In one more implementation the database may be located internally to the devices 106. The database 108 may store or provided access historical data and physical data.

In an implementation of the present subject matter, system 102 is configured to generate material model. In another implementation, the system 102 may include a material module generating module 110 configured to generate a material model utilizing input data. In an implementation, the system obtains the input data through device 106. Further, the system obtains historical data from the database 108. The input data may include class of material, type of material, geometric dimensions, environmental properties, and material properties. The historical data may include previous generated material models and the materials models know in the art.

In the said implementation, the system 102 is configured to compute stress values and strain values. In the said implementation, artificial neural network methodology or any other methodology as understood by a person skilled in the art may be utilized to compute the stress strain values. Further, utilizing the stress values and the strain values, a primary material model is generated. In said another implementation, the material module generating module 110 may be configured to compute the stress and strain values and generate the primary material module.

In the implementation, the system 102 is further configured to estimate a coefficient of error and a trend factor. In an embodiment, the coefficient of error and the trend factor is estimated based on a comparison between the primary material model and historical data. The coefficient of error may be described as a value indicative of the error in the previous material model and the primary material model. The trend factor may be defined as the value indicating the trend of difference between the historical data and the primary material model. In the other implementation, the material module generating module 110 may be configured to estimate a coefficient of error and a trend factor.

Furthermore, in the described implementation the system 102 is configured to re-compute the stress values and the strain values based on the coefficient of error and trend factor. In an embodiment the same artificial neural network may be utilized to re-compute the stress strain values. In another embodiment, an evolutionary method may be utilized for re-computing the stress strain values. Further, utilizing the recomputed stress strain values, a secondary material model is generated by the system 102. In the described other implementation, the material module generating module 110 may be configured to re-compute the stress and strain values and generate the secondary material module.

In the implementation, utilizing the generated secondary material model, the system 102 is configured to develop a 2-dimension material model enabling virtual package design and testing. The developed 2-dimendion packaging material model may be further provided to the users through the devices or may be store in the data base. In an implementation any other known system for virtual package test may utilize 2-dimendion packaging material model to perform virtual testing and design validation. In the said other implementation, the material module generating module 110 may be configured to develop a 2-dimension material model enabling virtual package design and testing.

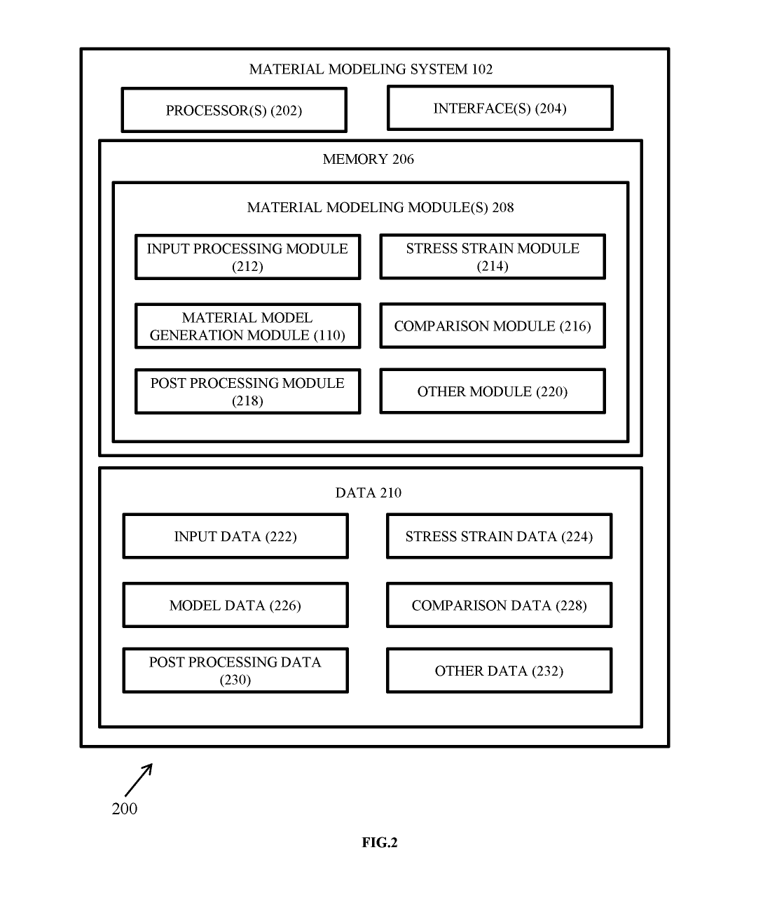

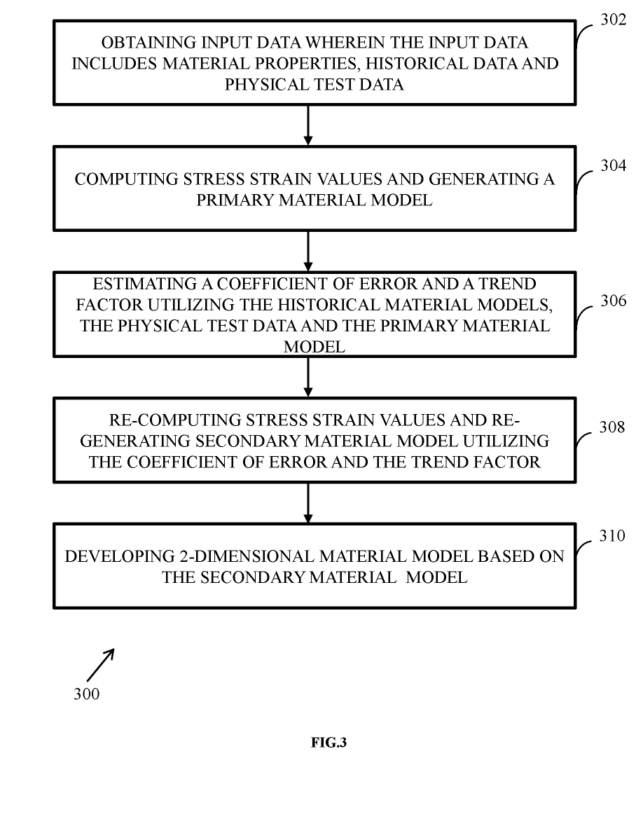

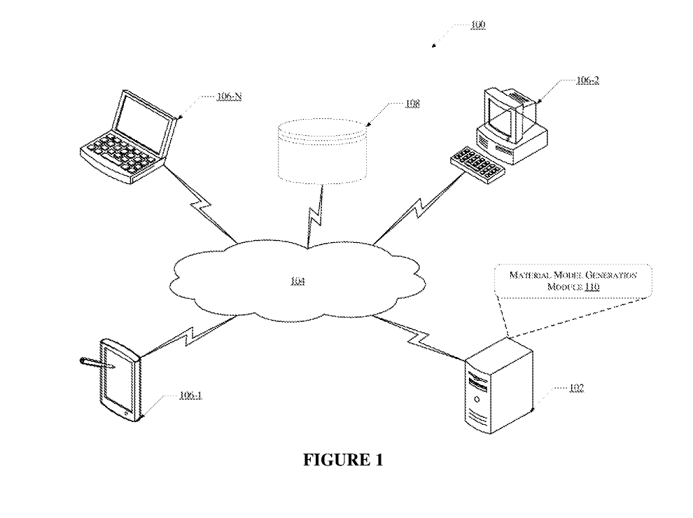

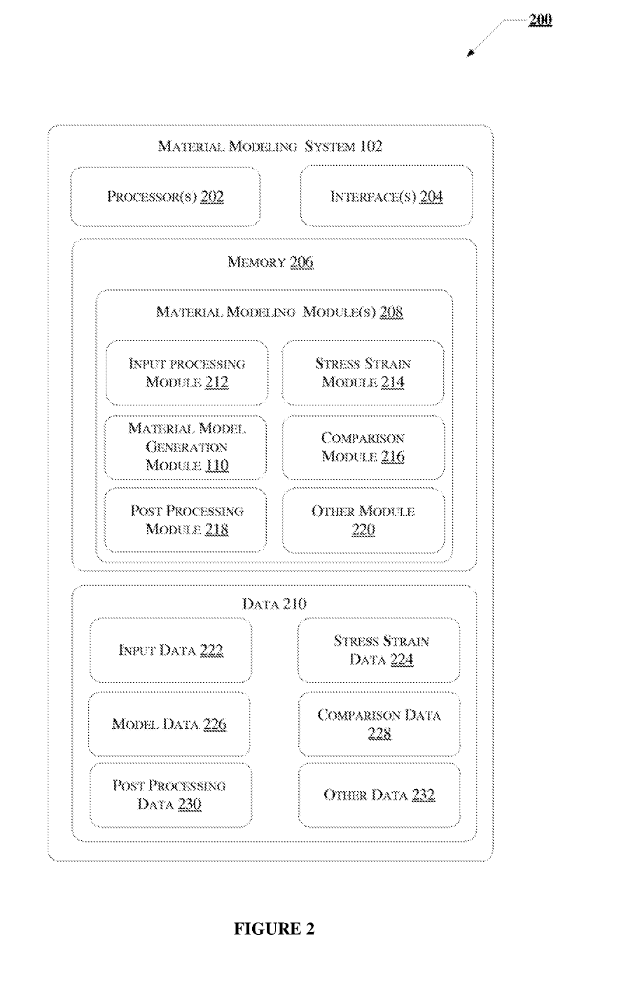

FIG. 2 illustrates the exemplary components of the material modeling system 102, according to an embodiment of the present subject matter. In one embodiment, the material modeling system 102 includes a processor(s) 202, interface(s) 204, a memory 206 coupled to the processor(s) 202, and a data 208 coupled to the processor(s) 202. In another implementation system 102 may be a standalone system coupled to various device 106 and database 108. In one other implementation system 102 installed inside the device 106.

The processor(s) 202 may be implemented as one or more microprocessors, microcomputers, microcontrollers, digital signal processors, central processing units, state machines, logic circuitries, and/or any devices that manipulate signals based on operational instructions. Among other capabilities, the processor(s) 202 is configured to fetch and execute computer-readable instructions stored in the memory 206.

The interface(s) 204 may include a variety of software and hardware interfaces, for example, a web interface, a graphical user interface, etc., allowing the material modeling system 102 to interact with the user devices 104. Further, the interface(s) 204 may enable the material modeling system 102 to communicate with other computing devices, such as web servers and external data servers (not shown in figure). The interface(s) 204 can facilitate multiple communications within a wide variety of networks and protocol types, including wired networks, for example LAN, cable, etc., and wireless networks such as WLAN, cellular, or satellite. The interface(s) 204 may include one or more ports for connecting a number of devices to each other or to another server.

The memory 206 can include any computer-readable medium known in the art including, for example, volatile memory, for example, Random Access Memory (RAM), and/or non-volatile memory, for example, Erasable Programmable Read Only Memory (EPROM), flash memory. In one embodiment, the memory 206 includes module(s) 208.

In one implementation, the modules 208 further include an input processing module 212, a stress strain module 214, a model generation module 110, comparison module 216, and a post processing module 218. The modules 208 may also include other modules 220 for providing various other functionalities of the material modeling system 102. It will be appreciated by any person skilled in the art, that such modules may be represented as a single module or a combination of different modules.

The data 210 serves, amongst other things, as a repository for storing data fetched, processed, received and generated by one or more of the modules 208. In one implementation, the data 210 may include input data 222, stress strain data 224, model data 226, comparison 228, post processing data 230 and other data 232. In one embodiment, the data 210 may be stored in the memory 206 in the form of data structures. Additionally, the aforementioned data can be organized using data models, such as relational or hierarchical data models.

In accordance to the present subject matter, a system for package material modeling is described herein. In an implementation, the input processing module 212 is configured to obtain input data from the user and historical data from the database 108. The user may include an individual or a group of individuals manually or automatically providing the input data, any software or a system configured to provide input data. The input data may include Edge Crush Test (ECT) values in the cross direction (CD) and machine direction (MD), Flat Crush Test (FCT), medium-flute specification, paper caliper for the plys, and basis weight for the plys. In another implementation, the input processing module 212 is configured to process the input data utilizing the equations (1) to (4). Further, the input processing module 212 is configured to store the input data and processed input data in the input data 222.

$$\begin{matrix}ECT = 0.7 * ( 8.1551 * Basis {wt}_{Liner 1} + 1716756.512 * ( {Caliper}_{liner 1} / 1000000 ) + 119.9121 + 8.1551 * Basis {wt}_{Liner 2} + 1716756.512 * ( {Caliper}_{liner 2} / 1000000 ) + 119.9121 + 1.41 * 8.1551 * Basis {wt}_{medium} + 1716756.512 * ( {Caliper}_{medium} / 1000000 ) + 119.9121 ) & ( 1 ) \\ SCT = \frac{ECT}{0.646 * 3.1985} & ( 2 ) \\ RCT = ( \frac{ECT}{1.3089} ) - 0.2758 & ( 3 ) \\ TSI = 0.35 \times {SCT}^{0.36} \times {RCT}^{0.64} & ( 4 )\end{matrix}$$

Where, ECT represents Edge Crush Test value

SCT represents Short span Compression Test value

RCT represents Ring Crush Test value

TSI represents Tensile Strength Index

In the implementation, the stress strain module 214 is configured to compute the stress values and strain values utilizing the input. In an implantation artificial neural network may be utilized to compute the stress values and the strain values. A neural network (NN), in the case of artificial neurons called artificial neural network (ANN) or simulated neural network (SNN), is an interconnected group of natural or artificial neurons that uses a mathematical or computational model for information processing based on a connectionist approach to computation. Typically, an ANN is an adaptive system that changes its structure based on external or internal information that flows through the network. In an example, the following pseudo code for ANN may be utilized.

// Read Data (section heading)
Read no. of input variables from training set
Read no. of output variables from training set
// Design Neural Networks (section heading)
Initialize no. of input nodes = no. of input variables
Initialize no. of hidden nodes = approx. (1.2 * no. of input variables)
Initialize no. of hidden layers = 1
Initialize no. of output nodes = no. of output variables
Initialize threshold for all nodes = 1
Initialize weight for all connectors = 1
Select activation function
// Loop through training cycles (section heading)
While (Cycle error > error specified)

Do (for each of training data point)

Calculate the outputs from inputs using Neural
network
Calculate the thresholds and weights using back

propagation

Calculate the error between first and recomputed
results
Use gradient descent method to reduce error
Set recomputed results as previous results

End Do

Calculate Cycle error

End While

//Report results (section heading)

Further, equation (5) may be utilized for calculating young's modules. Furthermore, the stress strain module 214 is configured to store the computed stress values and strain values in stress strain data 224.

$$E = \frac{TSI}{BasisWeight} \qquad ( 5 )$$

In the described implementation, the material model generation module 110 may be configured to generate a primary material model. The material model generation module 110 may integrate the compute young's modules (E) over the geometry to obtain the over primary material model. Furthermore, the material model generation module 110 is configured to store the generated primary material model in model data 226.

Further in the said implementation, comparison module 216 is configured to estimate a coefficient of error and trend factor. The comparison module 216 compares the primary material module with historical material models included in the historical data based on a predefined criteria. Further utilizing the difference between the primary material model historical material model and historical coefficient of error and trend factor a new coefficient of error and trend factor is computed. In addition, the comparison module 216 is configured to store the coefficient of error and the trend factor in the comparison data 228.

In accordance to described implementation, the stress strain module 214 and material module generation module 110 are further configured to re-compute the stress strain values and generate a secondary material module respectively. The re-computation and regeneration is based on the coefficient of error and the trend factor Furthermore, the stress strain module 214 and material module generation module 110 are configured store the recomputed stress strain values and the generated secondary material model in stress strain data 224 and model data 226 respectively.

Subsequently, the post processing module 218 is configured to develop a 2-dimensional packaging material model thus enabling virtual package design and testing. In an implementation the post processing may be configured to store the 2-dimensional packaging material module in post processing data 230. In another implementation, the post processing module 218 may be configured to store the 2-dimensional packaging material module in the database 108 or provide it to the user through the device 106.

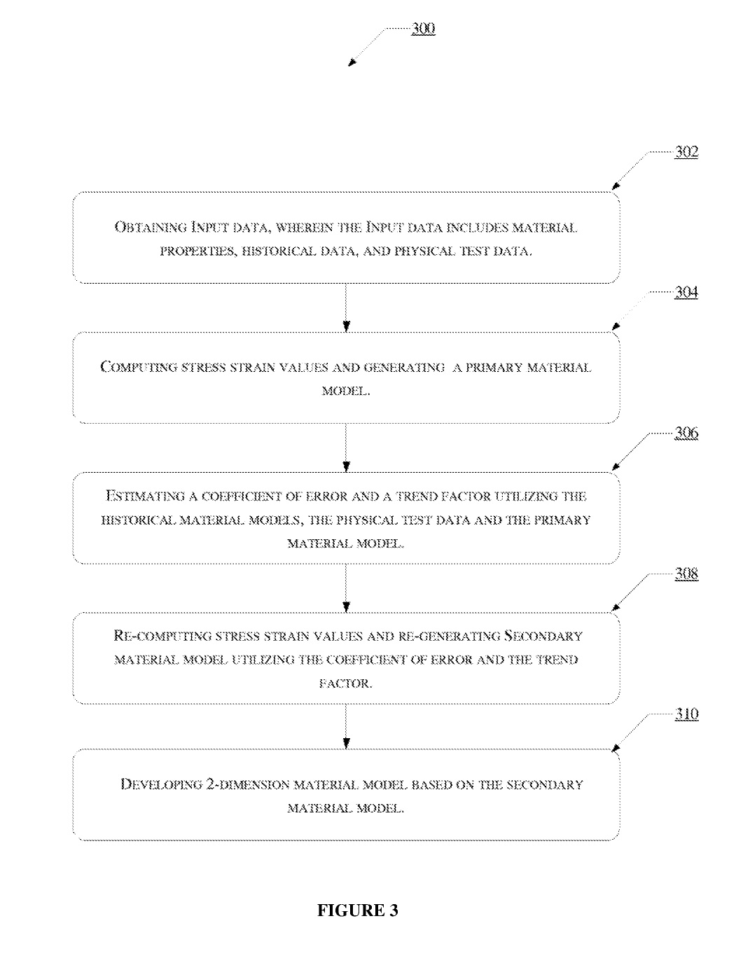

FIG. 3 illustrates an exemplary method 300 for generating a material model, according to an embodiment of the present subject matter. The method 300 may be described in the general context of computer executable instructions. Generally, computer executable instructions can include routines, programs, objects, components, data structures, procedures, functions, and modules, which perform particular functions or implement particular abstract data types. The method 300 may also be practiced in a distributed computing environment where functions are performed by remote processing devices that are linked through a communication network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300, or alternative methods. Additionally, individual blocks may be deleted from the method 300 without departing from the spirit and scope of the subject matter described herein. Furthermore, the method 300 can be implemented in any suitable hardware, software, firmware, or combination thereof.

With reference to method 300 as depicted in FIG. 3, as shown in block 302, input data is obtained. The input data may include material properties for example geometric properties, historical data, and physical test data. In an implementation the input processing module 212 may be configured to obtain input data and preprocess the input data.

As illustrated in block 304, primary stress values and strain values of the corrugated cardboard are computed. Further, a primary material model is generated utilizing the primary stress values and strain values. In an implementation stress strain module 214 is configured to compute primary stress strain values. In the implementation, material model generation module 110 is configured to generate primary material model.

As depicted in block 306, a coefficient of error and a trend factor is estimated. The estimation is based on a comparison between historical data, physical test data, and primary material model, utilizing a predefined criterion. In an implementation, comparison module 216 is configured to compare the primary material model and historical data and estimate a coefficient of error and a trend factor.

As shown in block 308, the secondary stress values and strain values are computed. Further, a secondary material model is generated. In an implementation stress strain module 214 is configured to compute secondary stress strain values. In the implementation, material model generation module 110 is configured to generate secondary material model.

As illustrated in block 310, 2-dimensional material model is developed enabling virtual package design and testing. the post processing module 218 is configured to develop a 2-dimensional packaging material model thus enabling virtual package design and testing.

In the present document, the words “exemplary, embodiment, implementation” are used to mean “serving as an example, instance or illustration”. Any embodiment or implementation or example is not to be constructed as preferred or advantages over other embodiment.

We claim:

1. A method for package material modeling, the method comprising:
computing stress values and strain values utilizing input data;
generating a primary material model utilizing the stress values and the strain values, wherein the primary material model is indicative of the material behavior characteristics; and estimating a coefficient of error and a trend factor; wherein the coefficient of error is indicative of error in the primary material model, wherein the trend factor is indicative of the trend in difference between historical data and the primary material model.

2. The method as claimed in claim 1, wherein the method further comprises:
re-computing the stress values and the strain values utilizing the coefficient of error and the trend factor;
generating a secondary material model based on the re-computed stress values and strain values, and wherein the secondary material model is indicative of the material behavior characteristics; and
developing a 2-dimensional model based on the secondary material model enabling virtual package testing.

3. The method as claimed in claim 1, wherein the method further comprises obtaining the input data, wherein the input data includes the material data, the historical data.

4. The method as claimed in claim 1, wherein the method further comprises comparing the historical data and the primary material model to estimate the coefficient of error and the trend factor.

5. The method as claimed in claim 1, wherein the method further comprises utilizing artificial neural network for computing the stress values and strain values

6. The method as claimed in claim 2, wherein the method further comprises utilizing artificial neural network for computing the stress values and strain values

7. A package material modeling system (102), the system comprising:
a processor; and
a memory coupled to the processor, the memory comprising:
an input processing module (212), wherein the input processing module (212) is configured to obtain the input data, wherein the input data includes the material data, the historical data.
a stress strain module (214), wherein the stress strain module (214) is configured to compute stress values and strain values utilizing input data
a material module generation module (108), wherein the material module generation module (108) configured to generate a primary material model utilizing the stress values and the strain values, wherein the primary material model is indicative of the material behavior characteristics; and
a comparison module (216) estimate a coefficient of error and a trend factor; wherein the coefficient of error is indicative of error in the primary material model, wherein the trend factor is indicative of the trend in difference between historical data and the primary material model.

8. The package material modeling system (102), as claimed in claim 7, is further comprising:
the stress strain module (214) further configured to re-compute the stress values and the strain values utilizing the coefficient of error and the trend factor;
the material module generation module (108) further configured to generate a secondary material model based on the re-computed stress values and strain values, and wherein the secondary material model is indicative of the material behavior characteristics; and

9. The package material modeling system (102), as claimed in claim 8 further comprising, a post processing module (218), wherein the developing post processing module (218) configured to develop a 2-dimensional model utilizing the secondary material model enabling virtual package testing.

10. A non-transitory machine-readable medium having embodied thereon a machine readable instruction for executing a method package material modeling, the method comprising:
obtaining the input data, wherein the input data includes the material data, the historical data.
computing stress values and strain values utilizing input data;
generating a primary material model utilizing the stress values and the strain values, wherein the primary material model is indicative of the material behavior characteristics;
estimating a coefficient of error and a trend factor; wherein the coefficient of error is indicative of error in the primary material model, wherein the trend factor is indicative of the trend in difference between historical data and the primary material model.
re-computing the stress values and the strain values utilizing the coefficient of error and the trend factor;
generating a secondary material model based on the re-computed stress values and strain values, and wherein the secondary material model is indicative of the material behavior characteristics; and
developing a 2-dimensional model based on the secondary material model enabling virtual package testing.
